(19) United States
(12) Patent Application Publication
(10) Pub. No.: US 2009/0010101 A1
(43) Pub. Date: Jan. 8, 2009

(54) Seismic streamer having longitudinally symmetrically sensitive sensors to reduce effects of longitudinally traveling waves

(76) Inventors: Nils Lunde, Houston, TX (US); Andre Stenzel, Richmond, TX (US); Oyvind Hillesund, Houston, TX (US); Stian Hegna, Hovik (NO)

Correspondence Address: E. Eugene Thigpen;Petroleum Geo-Services, Inc., P.O. Box 42805, Houston, TX, 77242-2805, US

(21) Appl. No.: 11/825,170

(22) Filed: Jul. 5, 2007

(51) Int. Cl. G01V 1/38

(52) U.S. Cl. 367/20

(57) ABSTRACT

A seismic streamer includes a jacket and at least one seismic sensor disposed in a sensor holder inside the jacket. The at least one sensor is oriented inside the sensor holder such that a response of the at least one sensor is substantially longitudinally symmetric.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of marine seismic survey apparatus and methods. More specifically, the invention relates to structures for marine seismic streamers that have reduced noise induced by effects of towing such streamers in the water.

2. Background Art

In marine seismic surveying, a seismic vessel travels on the surface of a body of water such as a lake or the ocean. The seismic vessel typically contains seismic data acquisition equipment, which includes devices such as navigation control, seismic source control, seismic sensor control, and signal recording devices. The seismic acquisition equipment causes a seismic source towed in the body of water, by the seismic vessel or another vessel, to actuate at selected times. The seismic source may be any type well known in the art of seismic acquisition, including air guns or water guns, or most commonly, arrays of air guns. Seismic streamers, also called seismic cables, are elongate cable-like structures that are towed in the body of water by the seismic survey vessel or by another vessel. Typically, a plurality of seismic streamers is towed behind the seismic vessel laterally spaced apart from each other. The seismic streamers contain sensors to detect the seismic wavefields initiated by the seismic source and reflected from acoustic impedance boundaries in the subsurface Earth formations below the water bottom.

Conventionally, seismic streamers contain pressure-responsive sensors such as hydrophones, but seismic streamers have also been proposed that contain particle motion sensors, such as geophones, in addition to hydrophones. The sensors are typically located at selected intervals along the length of seismic streamers.

Seismic streamers also include electronic components, electrical wiring and may include other types of sensors. Seismic streamers are typically assembled from sections, each section being approximately 75 meters in length. A number of such sections are joined end to end, and can extend the assembled streamer to a total length of many thousands of meters. Position control devices, such as depth controllers, paravanes, and tail buoys are affixed to the streamer at selected positions and are used to regulate and monitor the movement of the streamer in the water. During operation, the seismic sources and streamers are typically submerged at a selected depth in the water. The seismic sources are typically operated at a depth of 5-15 meters below the water surface and the seismic streamers are typically operated at a depth of 5-40 meters.

A typical streamer section consists of an external jacket, connectors, spacers, and strength members. The external jacket is formed from a flexible, acoustically transparent material such as polyurethane and protects the interior of the streamer section from water intrusion. The connectors are disposed at the ends of each streamer section and link the section mechanically, electrically and/or optically to adjacent streamer sections and, therefore, ultimately link it to the seismic towing vessel. There is at least one, and are usually two or more such strength members in each streamer section that extend the length of each streamer section from one end connector to the other. The strength members provide the streamer section with the capability to carry axial mechanical load. A wire bundle or cable also extends the length of each streamer section, and can contain electrical power conductors and electrical data communication wires. In some instances, optical fibers for signal communication are included in the wire bundle.

Typically, hydrophones or groups of hydrophones are located within the streamer section. The hydrophones are frequently mounted within corresponding spacers for protection. The distance between hydrophone containing spacers is ordinarily about 0.7 meters. A hydrophone group, typically comprising 16 hydrophones, thus extends for a length of about 12.5 meters. The hydrophones in a group are typically connected in series to cancel effects of certain types of noise to which the streamer may be exposed. The interior of the seismic streamers is typically filled with a void filling material to provide buoyancy and desired acoustic properties. Many seismic streamers have been filled with a liquid, such as oil or kerosene.

Ideally, in a streamer moving at constant speed, all the streamer components including the jacket, the connectors, the spacers, the strength members, wire bundle, sensors and liquid void filling material all move at the same constant speed and do not move relative to each other. Under actual movement conditions, however, transient motion of the streamers takes place, such transient motion being caused by events such as pitching and heaving of the seismic vessel, movement of the paravanes and tail buoys attached to the streamers, strumming of the towing cables attached to the streamers caused by vortex shedding on the cables, and operation of depth-control devices located on the streamers. Any of the foregoing types of transient motion can cause transient motion (stretching) of the strength members. Transient motion of the strength members displaces the spacers or connectors, causing pressure fluctuations in the liquid void filling material that are detected by the hydrophones. Pressure fluctuations radiating away from the spacers or connectors also cause the flexible outer jacket to compress in and bulge out in the form of a traveling wave, giving the phenomenon “bulge waves” its name.

In addition, there are other types of noise, often called “flow noise”, which can affect the quality of the seismic signal detected by the hydrophones. For example, vibrations of the seismic streamer can cause extensional waves in the outer jacket and resonance transients traveling down the strength members. A turbulent boundary layer created around the outer jacket of the streamer by the act of towing the streamer can also cause pressure fluctuations in the liquid core-filling material. In liquid filled streamer sections, the extensional waves, resonance transients, and turbulence-induced noise are typically much smaller in amplitude than the bulge waves, however they do exist and affect the quality of the seismic signals detected by the hydrophones. Bulge waves are usually the largest source of vibration noise because these waves travel in the liquid core material filling the streamer sections and thus act directly on the hydrophones.

It is known in the art to replace the liquid core material in a streamer section with a soft, flexible solid core material, such as gel. The introduction of a softer, flexible solid material may block the development of bulge waves compared to a liquid core material. Using a soft, flexible material will eliminate a substantial portion of the problem with “bulge waves”, but the so-called Poisson effect from the strength members can increase. Because of the relatively high tensile stiffness of the strength members, transients generally travel along the strength members at velocities near to or greater than that of the sound velocity in water, such velocities typically in the range of 1000 to 1500 meters per second. The actual velocity of transients along the strength members depends mainly on the elastic modulus of the strength member material and the tension applied to the streamer as it is towed in the water. The lower the elastic modulus the more compliant the streamer will be, and thus the more transient energy it will dissipate as heat and the less will pass through the strength member. Special elastic sections are normally placed at either end of a streamer cable to reduce the effects of transients.

There is still a need to further improve the attenuation of longitudinal waves transmitted through the strength members of marine seismic streamers.

### SUMMARY OF THE INVENTION

One aspect of the invention is a seismic streamer. A seismic streamer according to this aspect of the invention includes a jacket and at least one seismic sensor disposed in a sensor holder inside the jacket. The at least one sensor is oriented inside the sensor holder such that a response of the at least one sensor is substantially longitudinally symmetric.

A seismic streamer according to another aspect of the invention includes a jacket covering an exterior of the streamer. At least one strength member extends along the length of the jacket. The strength member is disposed inside the jacket. At least one array of sensors is disposed inside the jacket along the strength member. Each sensor in the at least one array is disposed in a sensor holder. Each sensor in the array is oriented inside the respective sensor holder such that a response of each sensor is substantially longitudinally symmetric. An acoustically transparent material fills void space in the interior of the jacket.

Other aspects and advantages of the invention will be apparent from the description and claims which follow.

### BRIEF DESCRIPTION OF THE DRAWINGS

FIG. 1 shows typical marine seismic data acquisition using a streamer according to one embodiment of the invention.

FIG. 2 shows a cut away view of one embodiment of a streamer segment according to the invention.

FIG. 3 shows one example of a transducer of a seismic sensor.

FIG. 4 shows another example of a transducer formed from half of the element shown in FIG. 3.

FIG. 5 shows an example of a cylindrical hydrophone used in some examples

FIG. 6 shows another example of a seismic sensor placed in a sensor spacer.

FIGS. 7A, 7B, 8A, 8B, 9A and 9B show other arrangements of a seismic sensor placed in a sensor holder, and other examples of a sensor holder.

### DETAILED DESCRIPTION

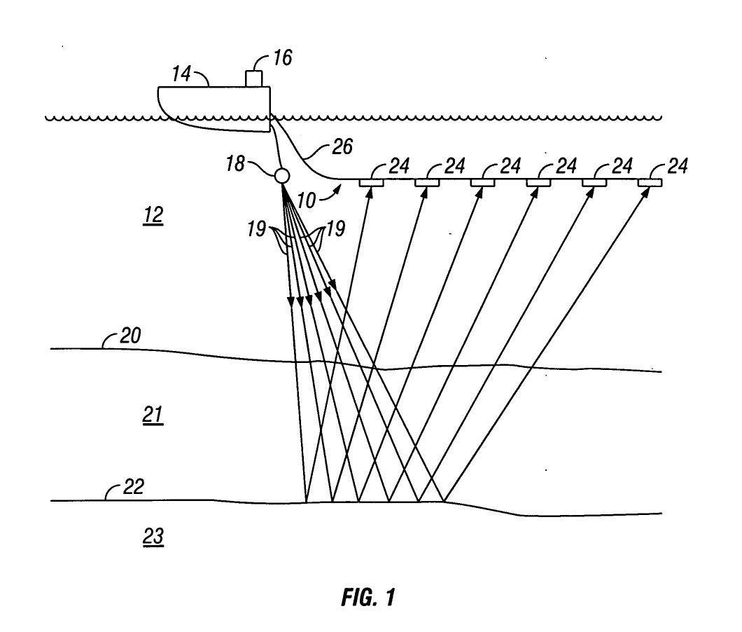

FIG. 1 shows an example marine seismic data acquisition system as it is typically used for acquiring seismic data. A seismic vessel 14 moves along the surface of a body of water 12 such as a lake or the ocean. The marine seismic survey is intended to detect and record seismic signals related to structure and composition of various subsurface formations 21, 23 below the water bottom 20. The seismic vessel 14 includes source actuation, data recording and navigation equipment, shown generally at 16 and referred to for convenience as a “recording system.” The seismic vessel 14, or a different vessel (not shown), can tow one or more seismic energy sources 18, or arrays of such sources in the water 12. The seismic vessel 14 or a different vessel tows at least one seismic streamer 10 near the surface of the water 12. The streamer 10 is coupled to the vessel 14 by a lead in cable 26. A plurality of sensor arrays 24 can be disposed at spaced apart locations along the streamer 10. The sensor arrays 24, as will be explained in more detail below, are formed by mounting a seismic sensor inside each one of a plurality of sensor spacers in a particular manner and disposing the sensor spacers at spaced apart locations along the streamer 10.

During operation, certain equipment (not shown separately) in the recording system 16 causes the source 18 to actuate at selected times. When actuated, the source 18 produces seismic energy 19 that emanates generally outwardly from the source 18. The energy 19 travels downwardly, through the water 12, and passes, at least in part, through the water bottom 20 into the formations 21, 23 below. Seismic energy 19 is at least partially reflected from one or more acoustic impedance boundaries 22 below the water bottom 20, and travels upwardly whereupon it may be detected by the sensors in each sensor array 24. Structure of the formations 21, 23, among other properties of the Earth's subsurface, can be inferred by travel time of the energy 19 and by characteristics of the detected energy such as its amplitude and phase.

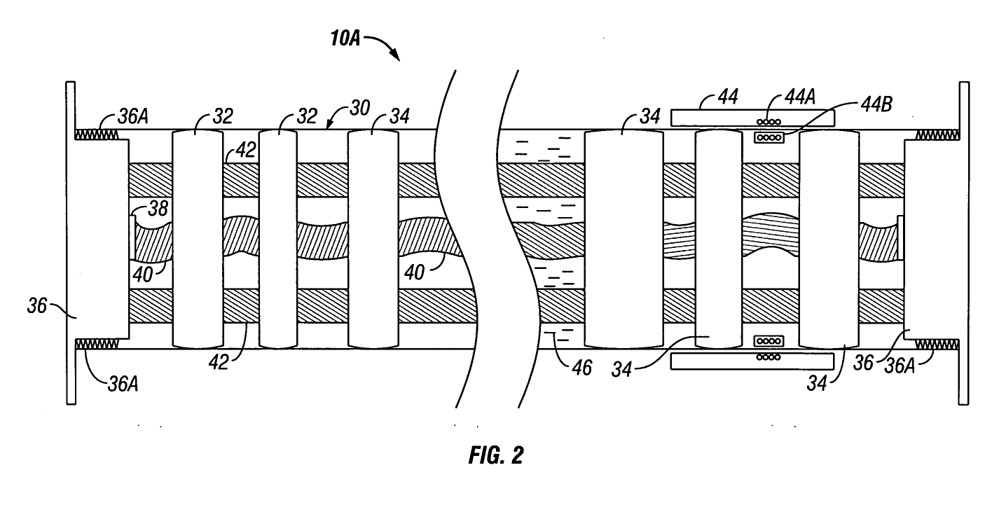

Having explained the general method of operation of a marine seismic acquisition system including at least one streamer, an example embodiment of a streamer segment according to the invention will be explained with reference to FIG. 2. FIG. 2 is a cut away view of a portion (segment) 10A of a typical marine seismic streamer (10 in FIG. 1). A streamer as shown in FIG. 1 may extend behind the seismic vessel (14 in FIG. 1) for several kilometers, and is typically made from a plurality of streamer segments 10A as shown in FIG. 2 connected end to end behind the vessel (14 in FIG. 1).

The streamer segment 10A in the present embodiment may be about 75 meters overall length. A streamer (such as shown at 10 in FIG. 1) thus may be formed by connecting a selected number of such segments 10A end to end. The segment 10A includes a jacket 30, which in the present example can be made from 3.5 mm thick transparent polyurethane and has a nominal external diameter of about 62 millimeters. In each segment 10A, each axial end of the jacket 30 may be terminated by a coupling/termination plate 36. The coupling/termination plate 36 may include rib elements 36A on an external surface of the coupling/termination plate 36. Such surface is inserted into one end of the jacket 30, so as to seal against the inner surface of the jacket 30 and to grip the coupling/termination plate 36 to the jacket 30, when the jacket 30 is secured by an external clamp (not shown). In the present example, two strength members 42 can be coupled to the interior of each coupling/termination plate 36 and can extend the length of the segment 10A. In a particular implementation of the invention, the strength members 42 may be made from a fiber rope containing or consisting of a fiber sold under the trademark VECTRAN, which is a registered trademark of Hoechst Celanese Corp., New York, N.Y. The strength members 42 transmit axial load along the length of the segment 10A. When one segment 10A is coupled end to end to another such segment (not shown in FIG. 2), the mating coupling/termination plates 36 are coupled together using any suitable connector, so that the axial force is transmitted through the coupling/termination plates 36 from the strength members 42 in one segment 10A to the strength members in the adjoining segment.

The segment 10A can include a number of buoyancy spacers 34 disposed in the jacket 30 and coupled to the strength members 42 at spaced apart locations along their length. The buoyancy spacers 34 may be made from foamed polyurethane or other suitable, selected density material. The buoyancy spacers 34 have a density selected to provide the segment 10A preferably with approximately the same overall density as the water (12 in FIG. 1), so that the streamer (10 in FIG. 1) will be substantially neutrally buoyant in the water (12 in FIG. 1). As a practical matter, the buoyancy spacers 34 provide the segment 10A with an overall density very slightly less than that of fresh water. Appropriate overall density may then be adjusted in actual use by adding selected buoyancy spacers 34 and fill media having suitable specific gravity. As will be further explained below, in some examples, the buoyancy spacers 34 may be arranged such that they are equally spaced on either side of one or more sensor holders 32.

The segment 10A includes a generally centrally located conductor cable 40 which can include a plurality of insulated electrical conductors (not shown separately), and may include one or more optical fibers (not shown). The cable 40 conducts electrical and/or optical signals from the seismic sensors (which will be further explained below) to the recording system (16 in FIG. 1). The cable 40 may in some implementations also carry electrical power to various signal processing circuits (not shown separately) disposed in one or more segments 10A, or disposed elsewhere along the streamer (10 in FIG. 1). The length of the conductor cable 40 within a cable segment 10A is generally longer than the axial length of the segment 10A under the largest expected axial stress on the segment 10A, so that the electrical conductors and optical fibers in the cable 40 will not experience any substantial axial stress when the streamer (10 in FIG. 1) is towed through the water by a vessel. The conductors and optical fibers in the cable 40 may be terminated in a connector 38 disposed in each coupling/termination plate 36 so that when the segments 10A are connected end to end, corresponding electrical and/or optical connections may be made between the electrical conductors and optical fibers in the conductor cable 40 in adjoining segments 10A. As will be readily appreciated by those skilled in the art, the cable 40 length is such that between sensor holders 32 and spacers 34, there is typically a catenary in the cable 40 between spacers 34 and sensor holders 32. In one example, to be further explained below, the catenary on opposed sides of each sensor holder 32 may be substantially the same or substantially symmetric.

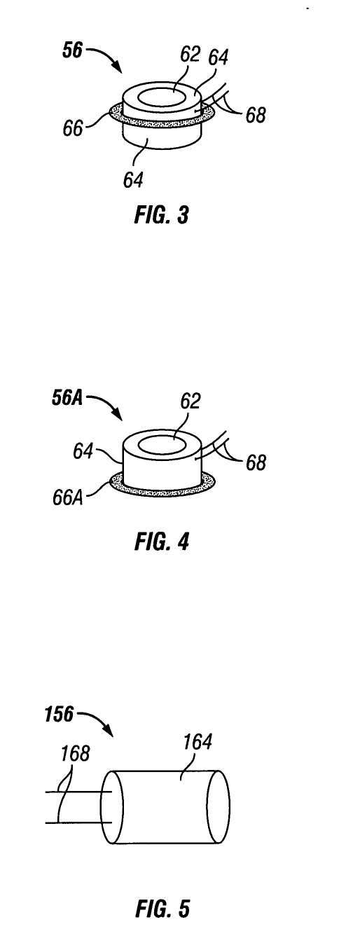

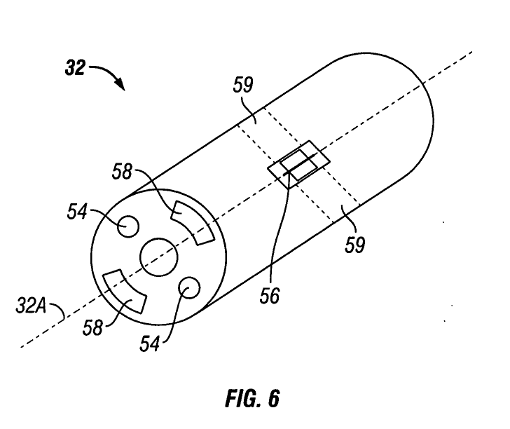

Sensors, which in the present example may be hydrophones, can each be disposed inside a respective sensor holder, shown in FIG. 2 generally at 32. A transducing element in each of the seismic sensors will be further explained with reference to FIGS. 3 and 4, and in the present example can be made from the transducer portion of a hydrophone sold under model number T-2BX by Teledyne Geophysical Instruments, Houston, Tex.

In the present example, each streamer segment 10A may include 96 such seismic sensors, disposed in arrays. Each such array may include sixteen individual seismic sensors connected in electrical series (or optical series if the sensors are optical sensors). It should be understood that in other implementations, the equivalent of a series coupled array may be effected by individually recording the signals from each sensor and summing the recorded signals. The number of sensors in an array is not a limit on the scope of this invention.

In a particular implementation, there are thus six such arrays, spaced apart from each other at about 12.5 meters in each segment 10A. The spacing between individual sensors in each array should be selected so that the axial span of the array is at most equal to about one half the wavelength of the highest frequency seismic energy intended to be detected by the streamer (10 in FIG. 1). It should be clearly understood that the types of sensors used, types of sensor spacers/holders used, the electrical and/or optical connections used, the number of such sensors, and the spacing between such sensors are only used to illustrate one particular example of the invention, and are not intended to limit the scope of this invention.

In other examples, the sensors may be particle motion sensors such as velocity sensors or accelerometers. A marine seismic streamer having particle motion sensors is described in U.S. patent application Ser. No. 10/233,266, filed on Aug. 30, 2002, entitled, Apparatus and Method for Multicomponent Marine Geophysical Data Gathering, assigned to an affiliated company of the assignee of the present invention and incorporated herein by reference. The sensors may also be optical sensors. Still other sensors may include combined transducing element and signal processing electronic circuitry called an “integrated micro electrical mechanical system.” One such sensing system is sold under model designation ADXL-330 by Analog Devices, Inc., Norwood, Mass.

At selected positions along the streamer (10 in FIG. 1) a compass bird 44 may be affixed to the outer surface of the jacket 30. The compass bird 44 includes a directional sensor (not shown separately) for determining the geographic orientation of the segment 10A at the location of the compass bird 44. The compass bird 44 may include an electromagnetic signal transducer 44A for communicating signals to a corresponding transducer 44B inside the jacket 30 for communication along the conductor cable 40 to the recording system (16 in FIG. 1). Measurements of direction are used, as is known in the art, to infer the position of the various sensors in the segment 10A, and thus along the entire length of the streamer (10 in FIG. 1). Typically, a compass bird will be affixed to the streamer (10 in FIG. 1) about every 300 meters (every four segments 10A). One type of compass bird is described in U.S. Pat. No. 4,481,611 issued to Burrage and incorporated herein by reference.

In the present example, the interior space of the jacket 30 may be filled with a material 46 such as buoyancy void filler (“BVF”), which may be a curable, synthetic urethane-based polymer. The BVF 46 serves to exclude fluid (water) from the interior of the jacket 30, to electrically insulate the various components inside the jacket 30, to add buoyancy to a streamer section and to transmit seismic energy freely through the jacket 30 to the sensors (in sensor holders 32). The BVF 46 in its uncured state is essentially in liquid form. Upon cure, the BVF 46 no longer flows as a liquid, but instead becomes substantially solid. However, the BVF 46 upon cure retains some flexibility to bending stress, substantial elasticity, and freely transmits seismic energy to the sensors (in sensor holders 32). It should be understood that the BVF used in the present embodiment only is one example of a gel-like substance that can be used to fill the interior of the streamer. Other materials could be also used. For example, heating a selected substance, such as a thermoplastic, above its melting point, and introducing the melted plastic into the interior of the jacket 30, and subsequent cooling, may also be used in a streamer according to the invention. Oil or similar material may also be used to fill the interior of the streamer.

The sensor holders 32, as explained in the Background section herein, are typically molded from a rigid, dense plastic to better protect the seismic sensors therein from damage during handling and use. An exterior configuration of the sensor holder 32 is preferably such that the sensor holder 32 fits snugly within the jacket 30. In some examples of a streamer according to the invention, the sensor spacers may also provide directional acoustic isolation between the BVF 46 and the seismic sensor therein. Other sensor holders may be fully exposed to pressure variations inside the jacket 30.

One example of a seismic sensor that can be used with the invention is shown schematically in FIG. 3. The seismic sensor includes a pair of axially opposed, cylindrically encased piezoelectric transducer elements 62. Each transducer element 62 may be disposed in a flanged, cylindrically shaped brass or bronze enclosure 64. The enclosures 64 are shown soldered together at their respective flange faces 66. The combined assembly of the two transducer elements 62 each in its respective enclosure 64 shown in FIG. 3 into a single transducer is referred to as a “pill” 56 because of its shape, which is generally right cylindrical with a short length along its axis. Electrical leads 68 from the transducer element 62 inside the enclosure 64 project through the wall of the enclosure 64 and enable electrical connection of the transducer 62 signal output to recording and/or telemetry circuitry, such as the recording system (FIG. 1).

The pill 56 shown in FIG. 3 is the active transducing element of the Teledyne Geophysical Instruments' T-2BX hydrophone referred to above. As commercially sold, the T-2BX hydrophone includes the pill 56 shown in FIG. 3 enclosed in a housing (not shown in FIG. 3). The housing is somewhat asymmetric in shape with respect to the pill 56 enclosed therein such housing may provide a certain degree of asymmetry (or directionality) to the response of the complete T-2BX hydrophone. Therefore, in some implementations, the pill 56 from a hydrophone, such as shown in FIG. 3, or portions of such pill, may be mounted directly inside a sensor holder, as will be further explained below. Alternatively, such pill 56 can be enclosed in a substantially symmetric housing (not shown), such as a molded plastic housing. Irrespective of the housing or casing configuration used for the seismic sensor's transducing element, it is believed that an enclosure with an axis of symmetry may enable mounting the sensor within a sensor holder (32 in FIG. 2) such that the sensor response is substantially symmetric with respect to a plane normal to the longitudinal axis of the streamer, called “longitudinally symmetric response” herein for convenience.

Referring to FIG. 4, in some examples, one or more half-pills, shown at 56A as encased transducer 62 with flange surface 66A, may be used individually, rather than joined at the flange faces as shown in FIG. 3. Irrespective of whether a whole pill (56 in FIG. 3) or one or more half pills 56A is used in any example, the generally right cylindrical shape of the transducer element enclosures shown in FIGS. 3 and 4 is believed to have substantially symmetrical response to pressure exerted normal to the cylindrical axis of the transducer case. When suitably mounted in a sensor holder, the combination of such sensor and sensor holder may result in substantially longitudinally symmetric response. It is believed that such longitudinally symmetric response may reduce the sensitivity of a seismic sensor streamer to longitudinally traveling pressure waves in the void filler material e.g., (BVF 46 in FIG. 2). The sensor holders shown in FIG. 4 generally provides a chamber for enclosing the seismic sensor that is substantially isolated from longitudinally traveling waves inside the streamer, and provides coupling to waves entering the streamer from outside.

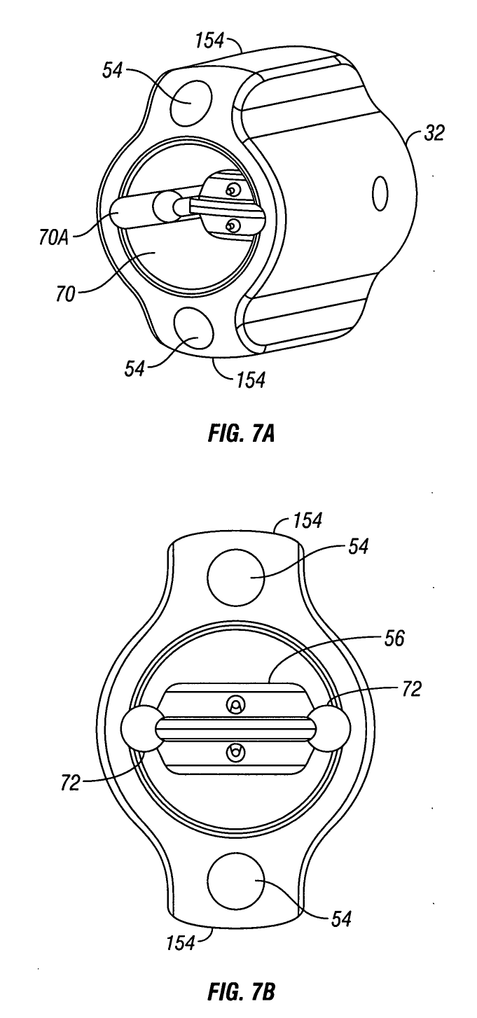

Another type of seismic sensor that may be used in some examples as a cylindrical hydrophone. One such hydrophone is sold under model number SQ20 by Sensor Technology Limited, Collingwood, Ontario, Canada L9Y 4K1. A configuration of such cylindrical hydrophone is shown in FIG. 5. The hydrophone 156 includes a substantially cylindrical transducer enclosure 164. Signal leads 168 exit the enclosure as shown.

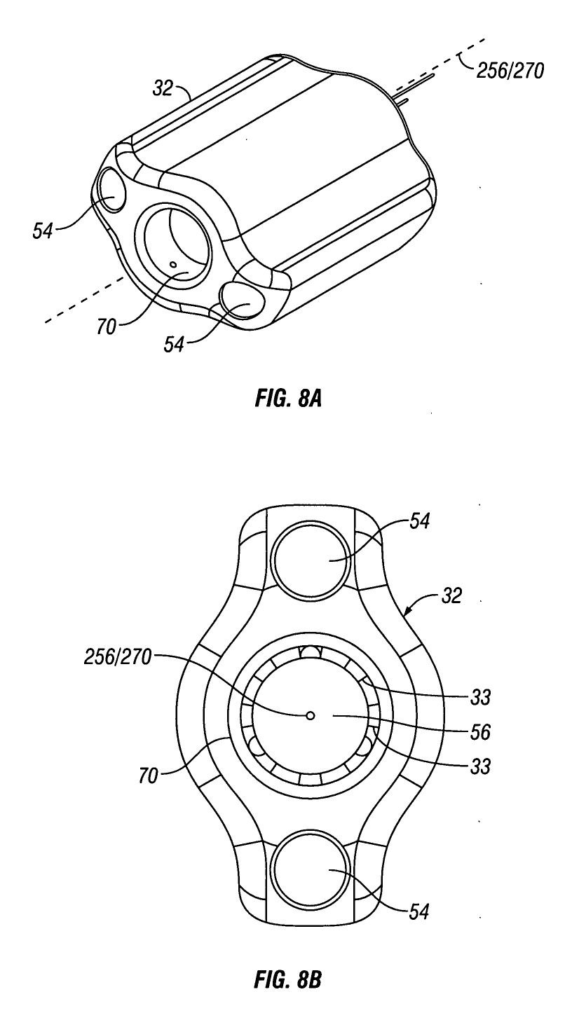

Another example of a sensor disposed in a sensor holder is shown in FIG. 6. The sensor holder 32 may be generally in the form of a right cylinder oriented along the longitudinal axis of the streamer (10 in FIG. 1). Passages 58 may extend through the sensor holder 32 near the circumferential edges of the holder 32 to provide a place for the cable (40 in FIG. 2). Other passages 54 may be provided for the strength members (42 in FIG. 2). A central channel 59 may be disposed roughly in the center of the sensor holder 32 to provide a place for mounting a pill 56 such as explained with reference to FIG. 3. Preferably the pill 56 is arranged such that the case is symmetrically disposed about a plane normal to the longitudinal axis 32A of the sensor holder 32. By so arranging the pill 56 in the sensor holder 32, it is believed that the response of the sensor (pill 56) will be substantially longitudinally symmetric (symmetric with respect to a plane normal to the longitudinal axis 32A).

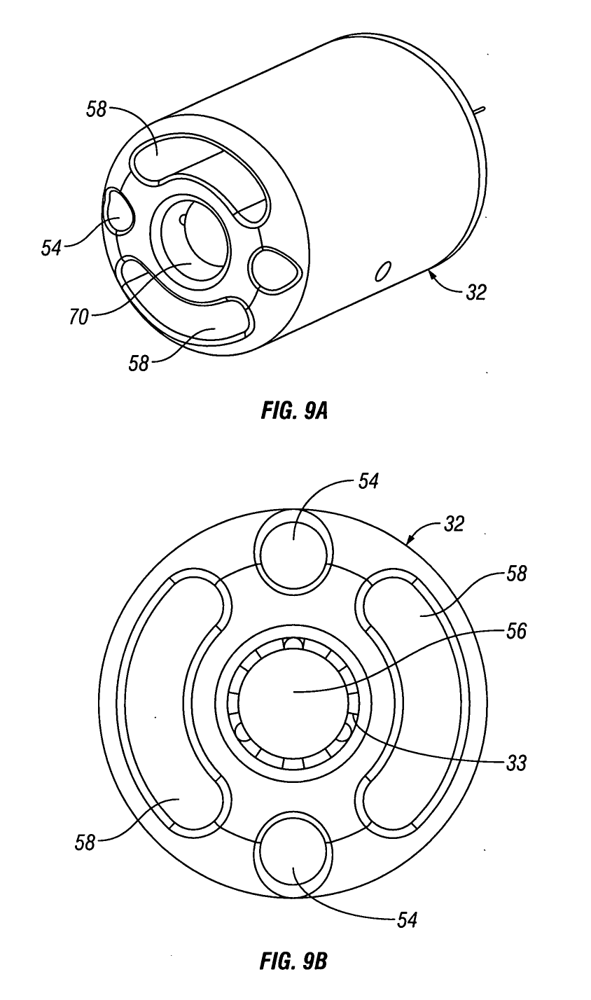

Another type of sensor holder is shown in oblique view in FIG. 7A and in end view in FIG. 7B. The sensor holder 32 may be made from plastic as described above. The shape of the sensor holder 32 may be such that only a small portion of the circumference of the sensor holder traverses a diameter approximately the same as the inner diameter of the jacket (30 in FIG. 2). Such portions are shown at 154 and are proximate to and surround passages 54 for insertion of the strength members (42 in FIG. 2). A central opening 70 for the seismic sensor 56 may extend longitudinally along the entire length of the sensor holder 32. The central opening 70 may include opposed, longitudinally extending grooves or channels 70A formed into the wall of the central opening 70. The sensor 56 may be retained in the sensor holder by applying soft elastomer bars 72 between the exterior of the sensor 56 and the grooves 70A. The elastomer bars 72 may have size selected to provide a friction fit between the sensor holder 32 and the sensor 56. The bars 72 may be made from an elastomer having compressibility selected to provide acoustic isolation between the sensor holder 32 and the sensor 56. Preferably, the sensor 56 is disposed in the sensor holder 32 at its longitudinal center and is arranged such that a bisecting plane of the sensor 56 is substantially parallel to the longitudinal axis of the sensor holder 32. Such arrangement may result in the acoustic response of the combined sensor and sensor holder being substantially longitudinally symmetric.

FIGS. 8A and 8B show another arrangement of sensor disposed in a sensor holder in oblique view and end view, respectively. The sensor holder 32 may be configured substantially the same as the sensor holder shown in FIGS. 7A and 7B. In FIGS. 8A and 8B, however, the seismic sensor 56 may be disposed in the central opening 70 such that the sensor's axis of symmetry 256 is substantially coaxial with the longitudinal axis 270 of the sensor holder 32. In FIG. 8B, the sensor 56 is shown as being retained in the sensor holder 32 using elastomer mounting tabs 33 to retain the sensor 56 inside the opening 70. Other examples may use elastomer rings (not shown). As in the previous example of FIGS. 7A and 7B, the sensor 56 is preferably disposed substantially at the longitudinal center of the sensor holder 32 such that the acoustic response of the combined sensor 56 and sensor holder 32 is substantially longitudinally symmetric.

Another arrangement, having a differently configured sensor holder is shown in FIGS. 9A and 9B in oblique view and end view, respectively. The sensor holder 32 may be substantially cylindrically shaped, and have an external diameter substantially the same as the inner diameter of the jacket (30 in FIG. 2). The sensor holder 32 may include longitudinal through passages 58 proximate the outer edge for passage of the cable (40 in FIG. 2) other devices in the streamer (10 in FIG. 1). The sensor holder may also include longitudinal through passages 54 for the strength members (42 in FIG. 2). The sensor holder 32 may include a central opening 70 disposed in the radial center of the sensor holder 32 and extending along the entire length of the sensor holder for disposing the seismic sensor 56. The seismic sensor 56 is shown mounted in substantially the same configuration as shown in FIGS. 8A and 8B, and as explained with reference to such figures may be disposed in the longitudinal center of the central opening 70 using elastomer tabs 33 or the like and arranged such that the sensor's axis of symmetry is substantially coaxial with the longitudinal axis of the sensor holder 32. Alternatively, the sensor 56 may be mounted in a sensor holder as in FIGS. 9A and 9B in the manner explained above with reference to FIGS. 7A and 7B.

Referring once again to FIG. 2, another aspect of the invention is to arrange each sensor holder 32 so that a longitudinal distance from the sensor holder 32 to an adjacent buoyancy spacer 34 disposed on each side of the sensor holder 32 is the same. Thus, the arrangement of sensor holder 32 and opposed buoyancy spacers 34 is substantially symmetric with respect to a bisecting plane of the sensor holder 32 perpendicular to the longitudinal axis of the streamer. In another aspect of the invention, the cable 40 may be arranged such that any catenary in the cable 40 between successive sensor holders 32 and buoyancy spacers 34 is substantially symmetrically arranged.

A streamer made using sensor spacers and sensor arrays as described herein may provide substantially reduced effect of noise related to axial vibrations than streamers made according to structures known in the art prior to the present invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A seismic streamer, comprising:
a jacket;
at least one seismic sensor disposed in a sensor holder inside the jacket, the at least one sensor oriented inside the sensor holder such that a response of the at least one sensor is substantially longitudinally symmetric.

2. The streamer of claim 1 wherein the at least one sensor comprises a transducing element disposed in an enclosure having an axis of symmetry.

3. The streamer of claim 2 wherein the enclosure is a right cylinder.

4. The streamer of claim 2 wherein the axis of symmetry is arranged along a plane normal to a longitudinal axis of the sensor holder.

5. The streamer of claim 4 wherein the sensor holder is substantially symmetric about a bisecting plane normal to the longitudinal axis of the sensor holder.

6. The streamer of claim 5 wherein the sensor includes two, opposed sensor segments, the segments arranged such that a longitudinal axis thereof is substantially coaxial with the longitudinal axis of the sensor holder.

7. The streamer of claim 1 wherein the at least one sensor comprises a hydrophone.

8. The streamer of claim 1 further comprising acoustically transparent filler material disposed in void space within the jacket.

9. The streamer of claim 1 wherein the sensor holder includes features to substantially isolate the at least one sensor from waves traveling longitudinally along the streamer.

10. The streamer of claim 1 further comprising a buoyancy spacer disposed longitudinally on each side of the sensor holder at substantially a same longitudinal distance from the sensor holder.

11. The streamer of claim 1 further comprising a cable having at least one of an electrical conductor and an optical conductor, the cable passing through the sensor holder, a catenary on the cable being substantially symmetric with respect to the sensor holder.

12. A seismic streamer comprising
a jacket covering an exterior of the streamer;
at least one strength member extending along the length of the jacket, the strength member disposed inside the jacket;
at least one array of sensors disposed inside the jacket along the strength member, each sensor in the at least one array disposed in a sensor holder; each sensor in the array oriented inside the respective sensor holder such that a response of each sensor is substantially longitudinally symmetric; and
an acoustically transparent material filling void space in the interior of the jacket.

13. The streamer of claim 12 wherein each sensor comprises a transducing element disposed in an enclosure having an axis of symmetry.

14. The streamer of claim 13 wherein each enclosure is a right cylinder.

15. The streamer of claim 13 wherein the axis of symmetry is arranged along a plane normal to a longitudinal axis of the sensor holder.

16. The streamer of claim 15 wherein each sensor holder is substantially symmetric about a bisecting plane normal to the longitudinal axis of the sensor holder.

17. The streamer of claim 16 wherein each sensor includes two, opposed sensor segments, the segments arranged such that a longitudinal axis thereof is substantially coaxial with the longitudinal axis of the sensor holder.

18. The streamer of claim 12 wherein each sensor comprises a hydrophone.

19. The streamer of claim 12 further comprising void filler material disposed in void space within the jacket.

20. The streamer of claim 12 wherein the sensor holders include features to isolate the respective sensor therein from waves traveling longitudinally along the streamer.

21. The streamer of claim 12 further comprising a buoyancy spacer disposed longitudinally on each side of at least one sensor holder at substantially a same longitudinal distance from the at least one sensor holder.

22. The streamer of claim 12 further comprising a cable having at least one of an electrical conductor and an optical conductor, the cable passing through each sensor holder, a catenary on the cable being substantially symmetric with respect to each sensor holder.
